(19) United States
(12) Patent Application Publication
(10) Pub. No.: US 2025/0274995 A1
(43) Pub. Date: Aug. 28, 2025

(54) Pairing Computing Devices by User-Friendly Touch-and-Connect Mechanism

(71) Applicant: Ka Yiu CHAN, Hong Kong (CN)

(72) Inventor: Ka Yiu CHAN, Hong Kong (CN)

(21) Appl. No.: 18/585,377

(22) Filed: Feb. 23, 2024

(51) Int. Cl. H04W 76/14; G06F 3/04883; H04W 12/069; H04W 12/50

(52) U.S. Cl. CPC H04W 76/14; G06F 3/04883; H04W 12/069; H04W 12/50

(57) ABSTRACT

A method for pairing first and second computing devices is provided. The first and second computing devices are equipped with a touchscreen and a K-card, respectively. When a user puts the K-card on the touchscreen, the K-card produces imitated touches to send parameters used in pairing the two devices to the first computing device, enabling the two devices to be automatically paired. Thereby, the user conveniently pairs the two devices by contacting the K-card with the touchscreen. The touchscreen also displays an active page selectable from pre-stored pages for the user to select a desired service to be provided by the first computing device to the second computing device via positioning the K-card on different regions of the active page. The first computing device is thus enabled to spontaneously provide the desired service after the two devices are paired without a need to further enquire the user.

### FIELD OF THE INVENTION

The present invention generally relates to a method for pairing computing devices under a communication protocol. In particular, the present invention relates to a touch-and-connect mechanism for pairing the computing devices in a user-friendly way.

### BACKGROUND

Pairing is a process used in computer networking for establishing a connection between two computing devices to allow data transfer between them. If a user of a mobile computing device wishes to connect the device to another mobile computing device, a peripheral device or a nearby public WiFi router, a substantial degree of user involvement is usually involved. For illustrating the need for substantial user involvement, consider an example of pairing a Bluetooth-enabled smartphone with another Bluetooth-enabled device. The pairing process is listed as follows.
1. The user goes to system-preference pages or system-configuration pages of the smartphone and turn on the Bluetooth option.
2. The smartphone scans for a nearby peripheral/router/device. The user waits the smartphone to complete the task of discovering nearby devices. After the discovering task is completed, the smartphone displays, on the smartphone's touchscreen, a list of nearby Bluetooth-enabled devices that are discovered.
3. The user chooses the intended Bluetooth-enabled device from the list of discovered devices to pair with. The user inputs his or her choice to the smartphone via the touchscreen.
4. The user turns on the intended Bluetooth-enabled device. Or the user enters a password on the smartphone's touchscreen to logon the intended Bluetooth-enabled device.

Note that the user is required to use his or her fingers to send inputs to the smartphone in performing the above-listed steps. The whole user experience in performing these steps is cumbersome and it actually creates a major user experience problem for people who are not computer-savvy such as senior citizens. This user-experience problem also occurs in the WiFi pairing process. Although it is attractive to have computing devices to automatically pair with each other without user involvement, not all computing devices are trusted by the user; it is inevitable that some user interaction is involved, at least in confirming that a device to be paired is trustworthy. It is desirable to have a technique for pairing computing devices with reduced or simplified user interaction so as to improve user experience.

After the user's computing device is paired with an external device, the computing device can use the service provided by the external device. Usually, the user has in his or her mind a desired service to be obtained from the external device. The user is then required to input a request for the desired service to the computing device or the external device. If inputting this request to the external device is combinable with the interaction between the external device and the user in initiating the pairing between the computing device and the external device, better user experience is achievable. It is also desirable that the above-mentioned technique for pairing computing devices is further designed to obtain the user's request for the desired service in the same user interaction so as to further improve user experience.

### SUMMARY OF THE INVENTION

The present invention provides a method for pairing a first computing device and a second computing device under a communication protocol. The first computing device includes a touchscreen. The second computing device includes a K-card configured to generate imitated touches.

In the method, the K-card produces a sequence of imitated touches on the touchscreen when the K-card contacts the touchscreen. The imitated-touch sequence is encoded with a data sequence. The data sequence includes one or more parameters for establishing a connection between the first and second computing devices under the communication protocol. The one or more parameters include an identifier of the second computing device for informing the first computing device to pair with the second computing device. The touchscreen senses touches made thereon, whereby the first computing device receives the imitated-touch sequence. The first computing device decodes the imitated-touch sequence to recover the data sequence such that the data sequence is securely transmitted from the K-card to the first computing device. In addition, the first computing device determines whether the second computing device is permitted to pair with the first computing device. Responsive to finding that the second computing device is permitted to pair with the first computing device, the first computing device establishes the connection between the first and second computing devices under the communication protocol according to the one or more parameters extracted from the recovered data sequence. Thereby, a user is enabled to conveniently pair the first and second computing devices by taking an action of contacting the K-card with the touchscreen.

In one option, the first computing device displays an active page on the touchscreen before the K-card contacts the touchscreen. The active page includes plural non-overlapping regions on the touchscreen such that the user is allowed to select one of the regions to position the K-card. The active page may be selectable from plural pre-stored pages by the user through finger-sliding the touchscreen. An individual region is associated with a corresponding service provided by the first computing device to the second computing device to be performed after the first and second computing devices are paired. Thereby, the user is additionally enabled to select a desired service provided to the second computing device when the user takes the action of contacting the K-card with the touchscreen. After the K-card contacts the touchscreen, the touchscreen detects a representative location of the touchscreen on which the K-card is positioned when contacting the touchscreen. Afterwards, the first computing device determines a user-selected region among the non-overlapping regions according to the representative location such that the first computing device is enabled to spontaneously provide the corresponding service associated with the user-selected region to the second computing device after the first and second computing devices are paired without a need to further enquire the user about the desired service to be provided.

In another option, the first computing device displays an active page on the touchscreen before the K-card contacts the touchscreen. The active page is selectable from plural pre-stored pages by the user through finger-sliding the touchscreen. The active page includes one or more non-overlapping regions on the touchscreen for the user to position the K-card. An individual region is associated with a corresponding service provided by the first computing device to the second computing device to be performed after the first and second computing devices are paired. Thereby, the user is additionally enabled to select a desired service provided to the second computing device when the user takes the action of contacting the K-card with the touchscreen. After the K-card contacts the touchscreen, the touchscreen detects a location of the touchscreen on which the K-card is positioned when contacting the touchscreen. Afterwards, the first computing device determines a user-selected region from the one or more non-overlapping regions displayed on the selected active page according to the representative location such that the first computing device is enabled to spontaneously provide the corresponding service associated with the user-selected region to the second computing device after the first and second computing devices are paired without a need to further enquire the user about the desired service to be provided.

In certain embodiments, whether the second computing device is permitted to connect to the first computing device is determined at least according to the one or more parameters provided by the second computing device.

In certain embodiments, the first computing device displays a message or a computer-generated icon on the touchscreen for indicating success of pairing after the connection between the first and second computing devices is established.

In certain embodiments, the K-card periodically generates the imitated-touch sequence such that when the K-card contacts the touchscreen, the imitated-touch sequence is automatically produced. Preferably, the imitated-touch sequence comprises a starting sequence for enabling the first computing device to detect arrival of the imitated-touch sequence obtained through the touchscreen.

In certain embodiments, the one or more parameters further include a passcode for authorizing the second computing device to logon the first computing device.

In certain embodiments, the one or more parameters further include a cryptographic key for enabling secure communication between the first and second computing devices under the communication protocol.

In certain embodiments, the first computing device is a mobile computing device and the second computing device is a peripheral device of the mobile computing device.

In certain embodiments, the first computing device is a wireless network router equipped with a touchscreen-based input/output device, and the second computing device is a mobile computing device.

In certain embodiments, the first computing device is a public computing server equipped with a touchscreen-based input/output device, and the second computing device is a mobile computing device.

In certain embodiments, the communication protocol is a Bluetooth protocol.

In certain embodiments, the communication protocol is a WiFi protocol.

Other aspects of the present disclosure are disclosed as illustrated by the embodiments hereinafter.

### BRIEF DESCRIPTION OF THE DRAWINGS

FIG. 1 depicts a flowchart for illustrating a touch-and-connect mechanism for pairing the first and second computing devices in accordance with an exemplary embodiment of the present invention.

FIG. 2 depicts an application example of the present invention that a K-card-enabled speaker not only provides user convenience in pairing with a tablet but also enables instant playing of music with animated visualization displayed on the tablet.

FIG. 3 depicts another application example that an interactive tablet provides product information to a K-card-enabled smartphone when the smartphone comes into contact with the tablet.

### DETAILED DESCRIPTION

As used herein, “computing device” means a standalone device or a distributed device having computing power. The standalone device is formed by physically integrating electronic components and/or integrated circuits (ICs) and/or functional units into one physical unit. The distributed device is formed by connecting different functional units together via communication links, wired or wireless. A single computing processor is deemed a computing device, and so is a desktop computer. A computer system formed by a desktop computer and various peripherals such as a mouse is also deemed a computer device. Another computer system formed by a desktop computer and a wireless mouse linked to the desktop computer via the Bluetooth protocol is also deemed a computer device. Other examples of computing device include a notebook computer, a computing server, a distributed server formed by separate physical servers linked by the Internet, a local area network (LAN) gateway, a LAN router, a WiFi access point, a Bluetooth-enabled smartphone, etc.

As used herein, “mobile computing device” means a computing device carriable by a person from one place to another. Apart from having computing power, a mobile computing device usually has wireless connectivity with one or more external networks. Examples of mobile computing device include a smartphone, a tablet, a smart watch, etc.

As used herein, “touchscreen” means an input/output (IO) device capable of displaying an image and sensing touches made by human fingers. Usually, the touchscreen detects locations of the touches made on the touchscreen, and clock times that these touches are made. The locations and the clock times form inputs to the touchscreen while the image displayed thereon forms an output.

As used herein, “K-card” means an electronic device configured at least to controllably produce touch-like inputs to a touchscreen. As a remark, it is not intended that the K-card is limited to possessing only the functionality of controllably producing the touch-like inputs. The K-card may incorporate other functionalities, such as reception of data from an external device.

### Technical Details of Present Invention

Disclosed herein is a method for pairing a first computing device and a second computing device under a communication protocol with a main advantage of reducing or simplifying user interaction. A user-friendly touch-and-connect mechanism is used in the method. Examples of the communication protocol include a Bluetooth protocol and a WiFi protocol.

One hardware enabler for realizing the disclosed method is a K-card. The K-card, which may be manufactured in card form, imitates a human fingertip touching or pressing a touchscreen. Since touching or pressing the touchscreen by the fingertip changes the capacitance at a touched region on the touchscreen and this capacitance change is detected by the touchscreen, the K-card imitates the action of fingertip touching by controllably and artificially changing the capacitance on the touched region. When the K-card is positioned on the touchscreen, imitated touches are sensed by the touchscreen, forming touch-like inputs to the touchscreen. The touch-like inputs are translated into data by a host computing device that uses the touchscreen. The K-card may be configured to generate one touch at a time, or multiple touches on different locations of the touchscreen at each time instant. When multiple touches are generated each time, a higher data rate can be supported. In case the K-card is integrated to a host computing device in some practical implementations, the K-card may receive power from the host computing device. Alternatively, the K-card may be self-powered by including a battery on-board. Other technical and operational details of K-card can be found in U.S. Pat. Nos. 9,589,161, 9,715,687 and US2018/0211071. The disclosures of U.S. Pat. Nos. 9,589,161, 9,715,687 and US2018/0211071 are incorporated herein by reference. The K-card may be embodied in a Duplex Response Interface for Touchscreens (DRIFT), which is configured not only to generate imitated touches to a touchscreen but also to receive data from the touchscreen via using photodetectors to detect light flashing so as to support bidirectional communication. Details of the DRIFT can be found in, e.g., U.S. Pat. No. 10,551,967.

The first and second computing devices are required to fulfill some hardware requirements as follows in order to use the disclosed method. The first computing device includes a touchscreen, and the second computing device includes a K-card configured to generate imitated touches. As examples for illustration, some specific realizations of the first and second computing devices as used in practical situations are described as follows. As a remark, the following list of practical situations is not exhaustive.

In a first situation, the first computing device is a smartphone equipped with a touchscreen, and the second computing device is a smart watch connectable to the smartphone through the Bluetooth protocol. A K-card is integrated to the smart watch and is located at a base plate of the smart watch. The K-card receives power from a battery of the smart watch. In general, the first computing device may be a mobile computing device and the second computing device may be a peripheral device of the first computing device.

In a second situation, the first computing device is a Bluetooth-enabled tablet and the second computing device is a Bluetooth-enabled smartphone. The tablet is equipped with a touchscreen as an IO input. A K-card is mounted to a back panel of the smartphone. In general, each of the first and second computing devices may be a mobile computing device.

In a third situation, the first computing device is formed as a distributed device having a WiFi access point and a touchscreen. The touchscreen is WiFi-enabled and is wirelessly linked to the WiFi access point. The second computing device is a smartphone that supports the WiFi protocol for communication over a wireless LAN (WLAN). A K-card is attached to a cover of the smartphone. The WiFi access point and the smartphone may belong to the same owner. In this case, the two computing devices are usually trusted entities to each other. It is also possible that the WiFi access point is a public access point while the smartphone is a private one. This situation occurs when, for instance, the user of the smartphone is riding on an aircraft equipped with an on-board WLAN. In this case, the smartphone does not necessarily trust the WiFi access point. Note that the WiFi access point is one form of a wireless network router. Instead of the WiFi access point, other types of wireless network router may be used in the first computing device. In general, the second computing device may be a mobile computing device.

In a fourth situation, the first computing device is formed as a distributed device having a (remote) computing server, a touchscreen communicated with the computing server through the Internet, and a WiFi access point nearby the touchscreen and Internet-connected to the computing server. The second computing device is a WiFi-enabled smartphone with a K-card attached to the smartphone's cover. Note that the computing server is a public server in most practical situations, e.g., when the user of the smartphone goes into a shopping mall that provides WiFi connectivity and is installed with touchscreens customized for interaction with customers. In general, the second computing device may be a mobile computing device.

In a fifth situation, the first computing device is same as the corresponding one detailed above for the fourth situation. The second computing device is a smartphone. Different from the fourth situation, the smartphone is occasionally connected to a K-card through a USB link. When the smartphone is physically disconnected from the K-card, the user may conveniently carry the K-card with the user's keys in a key holder.

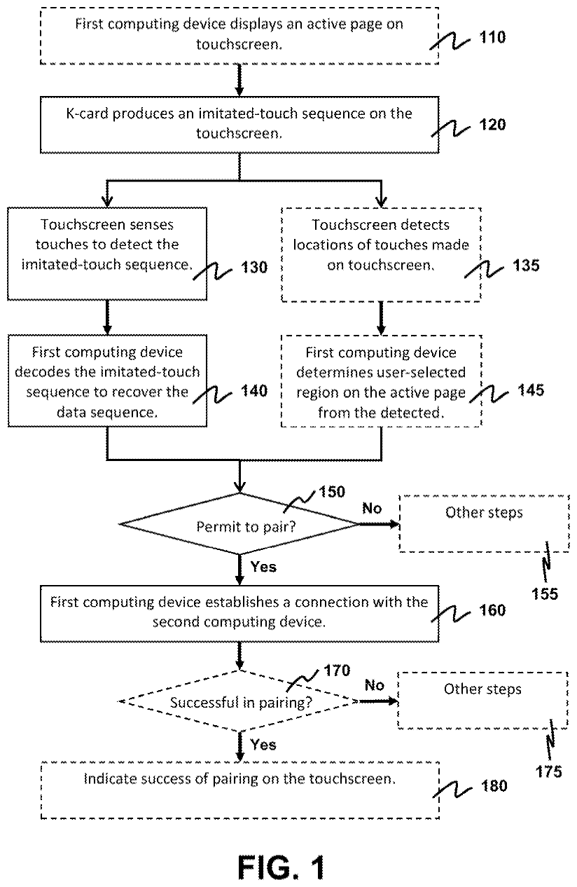

The disclosed method is exemplarily illustrated with the aid of FIG. 1, which depicts, in accordance with an exemplary embodiment of the present invention, a flowchart showing steps of a touch-and-connect mechanism for pairing the first and second computing devices under the communication protocol.

A first aspect of the disclosed method is to reduce or simplify user interaction during the event of pairing the first and second computing devices.

In a step 120, the K-card produces a sequence of imitated touches on the touchscreen when the K-card contacts the touchscreen, such as when a user of the second computing device puts the K-card on the touchscreen. The imitated-touch sequence is encoded with a data sequence. The data sequence is a sequence of digital data while the imitated-touch sequence is a sequence of physical changes in capacitance for imitating touching of a fingertip. One or more imitated touches are made on the touchscreen. Therefore, the one or more imitated touches are modulated (viz., encoded) by the data sequence. The data sequence includes one or more parameters for establishing a connection between the first and second computing devices under the communication protocol. The one or more parameters include an identifier of the second computing device for informing the first computing device to pair with the second computing device. Examples of the identifier include: a MAC address of the second computing device; and a nickname of the second computing device for enabling the first computing device to identify the second computing device's MAC address through a certain database.

Examples of other parameters that may be included in the one or more parameters include: a passcode issued from the first computing device and acquired by the second computing device for authorizing the second computing device to logon the first computing device; an authentication code generated by the second computing device for proving an authentic identity of the first computing device when the second computing device receives a message claimed to be sent from the first computing device; and a cryptographic key for enabling secure communication between the first and second computing devices under the communication protocol.

In one option, the K-card periodically generates the imitated-touch sequence such that when the K-card contacts the touchscreen, the imitated-touch sequence is automatically produced. Preferably, the imitated-touch sequence comprises a starting sequence serving as a prefix to the imitated-touch sequence for enabling the first computing device to detect arrival of the imitated-touch sequence obtained through the touchscreen.

Alternatively, if the K-card is installed with a touch sensor, the K-card needs not continuously send out the imitated-touch sequence. One example of the touch sensor is a photodiode for sensing light power of a surrounding environment such that a bright image generated by the touchscreen may trigger the photodiode when the K-card comes close to the touchscreen. When the K-card touches the touchscreen, the touch sensor triggers the K-card to generate the imitated-touch sequence. Preferably, the generation of the imitated-touch sequence is repeated such that even if the first computing device fails to capture the very first copy of the imitated-touch sequence, the first computing device can still acquire the imitated-touch sequence from a subsequent copy. Similarly, it is preferable that the imitated-touch sequence includes a starting sequence for enabling the first computing device to detect a starting point of the imitated-touch sequence.

Before the K-card contacts the touchscreen in the step 120, it is necessary to configure, usually by the first computing device, the touchscreen to sense any touch made thereon. It ensures that the imitated-touch sequence is detected by the touchscreen. Note that in practice, most often the touchscreen also detects a location of each touch made on the touchscreen.

In a step 130, the touchscreen senses touches made thereon. The imitated-touch sequence that is detected by the touchscreen is subsequently received by the first computing device. Thereafter, the first computing device decodes the imitated-touch sequence to recover the data sequence in a step 140. It follows that the data sequence is securely transmitted from the K-card to the first computing device.

After the data sequence is recovered by the first computing device, in a step 150, the first computing device determines whether the second computing device is permitted to pair with the first computing device. Most often it is determined at least according to the one or more parameters provided by the second computing device. For example, the identifier of the second computing device is checked if the second computing device is on the list of censored devices. It may also happen that the first computing device rejects all incoming requests for pairing regardless of the identity of the second computing device. For instance, the first computing device has already reached its full capacity of serving external computing devices.

If the first computing device finds that the second computing device is permitted to pair with the first computing device in the step 150, the first computing device performs a step 160 to establish the connection between the first and second computing devices under the communication protocol according to the one or more parameters extracted from the recovered data sequence. It thereby enables the user to conveniently pair the first and second computing devices by taking an action of contacting the K-card with the touchscreen, offering user convenience.

If, on the other hand, it is found that the second computing device is not permitted to pair with the first computing device, the first computing device may take appropriate actions (step 155), such as displaying a denial-to-pair message on the touchscreen.

After the step 160 is performed, preferably the first computing device checks whether establishment of the connection between the first and second computing devices is successful in a step 170. If it is successful, the first computing device may display a message or a computer-generated icon on the touchscreen for indicating (to the user) success of pairing (step 180). If not, the first computing device may take appropriate actions to follow up this unsuccessful event (step 175).

A second aspect of the disclosed method is to enable the first computing device to acquire information on a desired service from the user during the same user action of contacting the K-card with the touchscreen. Thereby, additional convenience to the user is provided. The desired service is one that the user wishes the first computing device to provide to the second computing device after the first and second computing devices are paired. With the availability of the desired-service information by the first computing device prior to pairing the two computing devices, it is possible that the desired service can be provided to the second computing device substantially-immediately after the pairing of the two computing devices is completed, thus further enhancing user experience.

The acquisition of the desired-service information is realized by taking additional steps on any of the embodiments detailed above in the first aspect of the disclosed method.

Refer to FIG. 1. Prior to the step 120, i.e. before the K-card contacts the touchscreen, the first computing device displays an active page on the touchscreen in a step 110. The active page includes plural non-overlapping regions on the touchscreen such that the user is allowed to select one of the regions to position the K-card. An individual region is associated with a corresponding service provided by the first computing device to the second computing device (viz., one option provided by the first computing device to the user to select) to be performed after the first and second computing devices are paired. The corresponding service is considered to be one option provided by the first computing device for the user to select. When the user positions the K-card on a region of the touchscreen where the service corresponding to this region is the desired service, the first computing device acquires the desired-service information, as well as the step 120 is initiated, followed by the steps 130, 140 to accomplish the secure transmission of the data sequence from the K-card to the first computing device. By the aforementioned arrangement, the user is additionally enabled to select the desired service provided to the second computing device when the user takes the action of contacting the K-card with the touchscreen.

Apart from sensing the touches in the step 130, the touchscreen also detects a representative location of the touchscreen on which the K-card is positioned (shorthanded as the representative location of the K-card) when contacting the touchscreen in a step 135. Usually, the steps 130 and 135 are simultaneously performed in practice. If the K-card imitates touches at only one location on the touchscreen, this single location is the representative location of the K-card. As mentioned above, it is possible that the K-card imitates touches on plural locations of the touchscreen, usually due to providing a higher data rate. In this case, the representative location of the K-card is determined according to the plural locations of the imitated touches. In one example, x and y coordinates of the representative location are determined by taking average on x coordinates and y coordinates of the plural imitated-touch locations, respectively, such that the representative location is the centroid of a polygon formed by the imitated touches. Since the touchscreen locations used by the K-card to imitate touches are classified as anchor points and information points (see US2018/0211071), in another example, the representative location of the K-card is determined as the centroid of a polygon formed by the anchor points.

After the representative location of the K-card is obtained, in a step 145, the first computing device determines a user-selected region among the non-overlapping regions shown on the active page according to the representative location of the K-card. From the user-selected region that is determined, the first computing device acquires the desired-service information. Advantageously, the first computing device is enabled to spontaneously provide the desired service (i.e. the corresponding service associated with the user-selected region) to the second computing device after the first and second computing devices are paired without a need to further enquire the user about the desired service to be provided. Preferably, the desired service is provided to the second computing device substantially-immediately after the first and second computing devices are paired.

It is possible that the first computing device has a large number of options (viz., provided services) for the user to select, and it may not be convenient to the user if all the options are visualized on one page. Optionally, the active page displayed on the touchscreen is selectable from plural pre-stored pages by the user through finger-sliding the touchscreen.

If multiple pre-stored pages are used, it is not necessary that each page is divided into multiple non-overlapping regions. Occupying the whole page may be advantageous in certain practical situations, for example, when the touchscreen is of a moderate or small size, and when it is foreseen that senior citizens or patients are routine users to use services provided by the first computing device.

In certain embodiments, the step 110 is modified as follows. The active page is selectable from plural pre-stored pages by the user through finger-sliding the touchscreen. Furthermore, a limitation that the active page has plural non-overlapping regions is relaxed. The active page can include one or more non-overlapping regions on the touchscreen for the user to position the K-card. The step 145 is modified such that the user-selected region is determined from the one or more non-overlapping regions displayed on the selected active page according to the representative location of the K-card.

### Application Examples

Two application examples related to the disclosed method are provided to illustrate the application advantage of using the disclosed method in enhancing user experience.

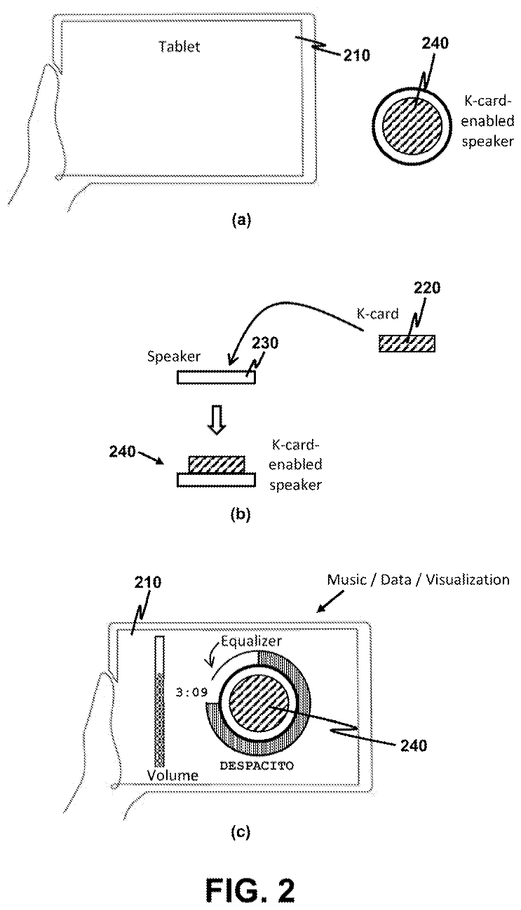

The first example is illustrated with reference to FIG. 2. It is shown that a K-card-enabled speaker 240 not only provides user convenience in pairing with a tablet 210 but also enables instant playing of music with animated visualization shown on the tablet 210. As shown in inset (b) of FIG. 2, the K-card-enabled speaker 240 is formed by attaching a K-card 220 to a Bluetooth-enabled speaker 230. When the K-card-enabled speaker 240 is placed on the touchscreen of the tablet 210, pairing between the tablet 210 and the K-card-enabled speaker 240 is automatically performed. Music is then played automatically and immediately by the K-card-enabled speaker 240. An added functionality is that the touchscreen of the tablet 210 also serves as a control panel in which a user interface (UI) can be displayed and automatically adapted to the location and orientation of the K-card 220 as shown in inset (c) of FIG. 2. The UI can provide additional functions such as volume change and/or choosing songs from a selected music-song album. The contents of the UI can come from a specific software application of the tablet 210, and the UI can be visually re-arranged/augmented to take into account the location and orientation of the K-card 220 on the touchscreen of the tablet 210. Thus, not only is the whole Bluetooth-based pairing process easier than conventional pairing methods, but also choosing an additional content and making volume control can be done in a user-friendly manner.

Additionally, the ad-hoc UI enabled by the touchscreen can complement the hardware interface (e.g., knobs and buttons that control volume, power, skip track, play/pause, etc.) of the speaker device. For example, the Beoplay A1 portable speaker has a 360-degree circular design with buttons plastered all around the speaker. To see these buttons, especially the power button, would require one to rotate the speaker to enable the user to see the buttons on the side. However, the touchscreen can display this button information at a bird's-eye view. It would make it much easier for a user to access these buttons/controls. Furthermore, the speaker can turn on itself automatically if the speaker is integrated with a K-card without a need to even press a power button.

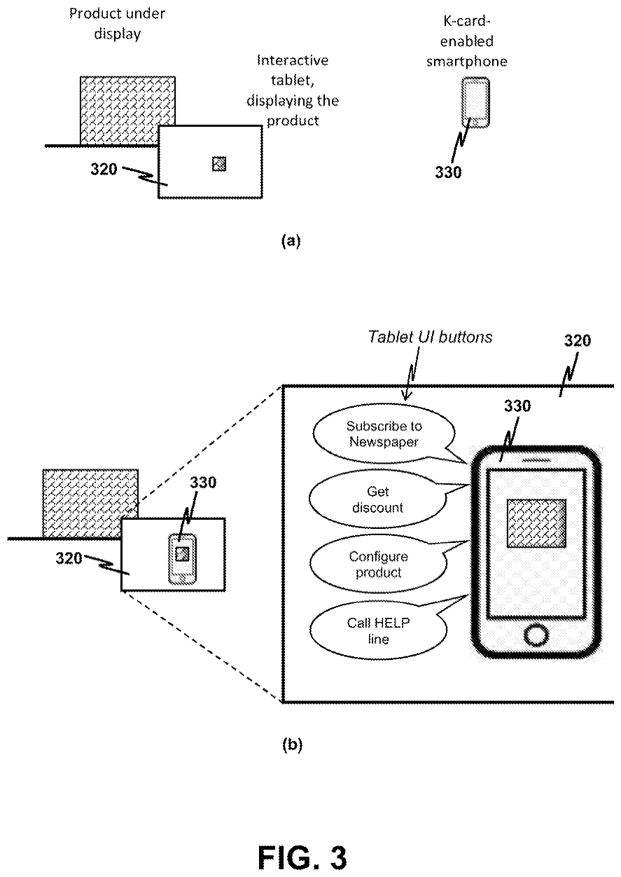

The second example is illustrated with reference to FIG. 3. FIG. 3 depicts an interactive tablet 320 that is Bluetooth-enabled for providing product information to a K-card-enabled smartphone 330 when the smartphone 330 comes into contact with the tablet 320. The smartphone 330 is also Bluetooth-enabled. In a shop, a mall or any other public place, it is often that customers wish to obtain localized information or commercial information from a retailer. A conventional approach is to enter personal information such as email address, phone number on the spot and the relevant files containing the required information is sent through corresponding channels. It is inconvenient and leads to bad user experience. Furthermore, a lot of people are unwilling to share their contact information to retailers. With the K-card-enabled smartphone 330, relevant files containing the required information can be transferred via a Bluetooth link without a need to provide personal contact information. In addition, an ad-hoc UI can be displayed on the smartphone 330 when the K-card is placed on the touchscreen of the tablet 320 as shown in inset (b) of FIG. 3. It can offer an additional intuitive means of interaction where customized files can be sent and customized interaction between the user and the retailer can be done.

### Comparison of the Disclosed Method against some Existing Methods

US 2007/0202807A1 discloses a method for pairing first and second Bluetooth devices while providing user convenience. A RFID tag is installed in the first Bluetooth device. The RFID tag contains bonding information of the first Bluetooth device. The second Bluetooth device has a RFID reader. When the user puts the first Bluetooth device close to the second Bluetooth device, the second Bluetooth device acquires the bonding information of the first Bluetooth device. The second Bluetooth device automatically performs the pairing operation with the first Bluetooth device based on the acquired bonding information.

Although both the method of US 2007/0202807A1 and the disclosed method of the present invention are able to accomplish automatic pairing of two computing devices by a user taking a one-tap action, the method disclosed herein is more versatile than the method of US 2007/0202807A1 in that an active page containing multiple options (different services to be provided) is displayed on the touchscreen for the user to select. The user is additionally enabled to select a desired service by taking a one-tap action of contacting the K-card with the touchscreen. On the other hand, a user using the method of US 2007/0202807A1 is required to make two hand-movement actions to accomplish the pairing of the two Bluetooth devices (or two computing devices in general). One action is to tap the first computing device on the second computing device for pairing the two computing devices. Another action is to use his or her finger to point to the touchscreen of the first or second computing device for selecting the desired service through the touchscreen, either before or after the two computing devices are paired. This analysis indicates that the disclosed method of the present invention is more convenient than the method of US 2007/0202807A1.

U.S. Pat. No. 9,277,391B2 discloses a method for pairing first and second Bluetooth devices by the first one displaying an image containing identification (ID) information (e.g., on a QR code) such that the second one can capture the ID information through a camera of the second Bluetooth device and thereafter the second Bluetooth device can automatically pair with the first one. A user is required to turn on the second Bluetooth device's camera, and to orient the camera toward the first Bluetooth device's touchscreen. Even if the touchscreen is made as large as a television, the user still needs to pay a considerable amount of attention in orienting the camera correctly toward the image on the touchscreen, let alone the need to turn on the camera. The method of U.S. Pat. No. 9,277,391B2 obviously requires a lot more of cognitive attention from the user than the method disclosed herein.

WO 2015/120795 A1 discloses a touch-screen-based device-pairing method for pairing a first device having a touch screen and a second device after a touch is made on the touch screen. The second device is selected from a set of devices. The identity of the second device is determined according to a location of the touch on the touch screen. CN 102629186 A1 discloses a technique for receiving a user input that specifies smartphones selected from a set of smartphones to be mutually paired. In the technique, respective smartphones in the set of smartphones are positioned side-by-side such that touch screens thereof are joined and arranged to form an enlarged touch screen. A user then draws a line on the enlarged touch screen. The selected smartphones for pairing are identified as certain smartphones whose touch screens are visited by the user-drawn line. In both disclosures of WO 2015/120795 A1 and CN 102629186 A1, the touch or the user-drawn line does not actively transmit data information to any smartphone through the touch screen thereof. In contrast, the K-card of the present invention produces a sequence of imitated touches on a touchscreen for data transmission when the K-card contacts the touchscreen.

What is claimed is:

1. A method for pairing a first computing device and a second computing device under a communication protocol, the first computing device including a touchscreen, the second computing device including a K-card configured to generate imitated touches, the method comprising:
when the K-card contacts the touchscreen, producing, by the K-card, a sequence of imitated touches on the touchscreen, wherein the imitated-touch sequence is encoded with a data sequence, the data sequence including one or more parameters for establishing a connection between the first and second computing devices under the communication protocol, the one or more parameters including an identifier of the second computing device for informing the first computing device to pair with the second computing device;
sensing, by the touchscreen, touches made thereon, whereby the first computing device receives the imitated-touch sequence;
decoding, by the first computing device, the imitated-touch sequence to recover the data sequence such that the data sequence is securely transmitted from the K-card to the first computing device;
determining, by the first computing device, whether the second computing device is permitted to pair with the first computing device; and
responsive to finding that the second computing device is permitted to pair with the first computing device, establishing, by the first computing device, the connection between the first and second computing devices under the communication protocol according to the one or more parameters extracted from the recovered data sequence, thereby enabling a user to conveniently pair the first and second computing devices by taking an action of contacting the K-card with the touchscreen.

2. The method of claim 1 further comprising:
before the K-card contacts the touchscreen, displaying, by the first computing device, an active page on the touchscreen, wherein the active page includes plural non-overlapping regions on the touchscreen such that the user is allowed to select one of the regions to position the K-card, and wherein an individual region is associated with a corresponding service provided by the first computing device to the second computing device to be performed after the first and second computing devices are paired, thereby additionally enabling the user to select a desired service provided to the second computing device when the user takes the action of contacting the K-card with the touchscreen;
detecting, by the touchscreen, a representative location of the touchscreen on which the K-card is positioned when contacting the touchscreen; and
determining, by the first computing device, a user-selected region among the non-overlapping regions according to the representative location such that the first computing device is enabled to spontaneously provide the corresponding service associated with the user-selected region to the second computing device after the first and second computing devices are paired without a need to further enquire the user about the desired service to be provided.

3. The method of claim 2, wherein the active page is selectable from plural pre-stored pages by the user through finger-sliding the touchscreen.

4. The method of claim 1 further comprising:
before the K-card contacts the touchscreen, displaying, by the first computing device, an active page on the touchscreen, wherein the active page is selectable from plural pre-stored pages by the user through finger-sliding the touchscreen, wherein the active page includes one or more non-overlapping regions on the touchscreen for the user to position the K-card, and wherein an individual region is associated with a corresponding service provided by the first computing device to the second computing device to be performed after the first and second computing devices are paired, thereby additionally enabling the user to select a desired service provided to the second computing device when the user takes the action of contacting the K-card with the touchscreen;
detecting, by the touchscreen, a location of the touchscreen on which the K-card is positioned when contacting the touchscreen; and
determining, by the first computing device, a user-selected region from the one or more non-overlapping regions displayed on the selected active page according to the representative location such that the first computing device is enabled to spontaneously provide the corresponding service associated with the user-selected region to the second computing device after the first and second computing devices are paired without a need to further enquire the user about the desired service to be provided.

5. The method of claim 1, wherein whether the second computing device is permitted to connect to the first computing device is determined at least according to the one or more parameters provided by the second computing device.

6. The method of claim 1 further comprising:
displaying, by the first computing device, a message or a computer-generated icon on the touchscreen for indicating success of pairing after the connection between the first and second computing devices is established.

7. The method of claim 1 further comprising:
periodically generating, by the K-card, the imitated-touch sequence such that when the K-card contacts the touchscreen, the imitated-touch sequence is automatically produced.

8. The method of claim 7, wherein the imitated-touch sequence comprises a starting sequence for enabling the first computing device to detect arrival of the imitated-touch sequence obtained through the touchscreen.

9. The method of claim 1, wherein the one or more parameters further include a passcode for authorizing the second computing device to logon the first computing device.

10. The method of claim 1, wherein the one or more parameters further include a cryptographic key for enabling secure communication between the first and second computing devices under the communication protocol.

11. The method of claim 1, wherein the first computing device is a mobile computing device and the second computing device is a peripheral device of the mobile computing device.

12. The method of claim 1, wherein the first computing device is a wireless network router equipped with a touchscreen-based input/output device, and the second computing device is a mobile computing device.

13. The method of claim 1, wherein the first computing device is a public computing server equipped with a touchscreen-based input/output device, and the second computing device is a mobile computing device.

14. The method of claim 1, wherein the communication protocol is a Bluetooth protocol.

15. The method of claim 1, wherein the communication protocol is a WiFi protocol.
